(19) United States
(12) Patent Application Publication
(10) Pub. No.: US 2018/0071936 A1
(43) Pub. Date: Mar. 15, 2018

(54) SIZE-REDUCTION MACHINE AND CUTTING UNIT THEREFOR

(71) Applicant: Urschel Laboratories , Inc., Chesterton, IN (US)

(72) Inventor: Michael Scot Jacko, Valparaiso, IN (US)

(21) Appl. No.: 15/260,385

(22) Filed: Sep. 9, 2016

(51) Int. Cl. B26D 1/29; B26D 7/06; B26D 3/28

(52) U.S. Cl. CPC B26D 1/29; B26D 3/28; B26D 7/0625

(57) ABSTRACT

Size-reduction machines equipped with cutting units suitable for performing size reduction operations on products, including but not limited to food products. The cutting unit includes a frame secured to the machine at an exit of a feed passage of the machine. The frame defines an opening aligned with the exit of the feed passage. The cutting unit further includes a pulley rotatably mounted to the mounting frame and driven by a spindle of the machine. A knife is coupled to the pulley so as to rotate therewith about its axis. The knife has a central axis that coincides with the axis of the pulley, an axial surface facing the feed passage, and at least one blade between the central axis and an outer perimeter of the knife.

### BACKGROUND OF THE INVENTION

The present invention generally relates to methods and equipment for performing size reduction operations on products, including but not limited to food products.

Various types of equipment are known for reducing the size of products, for example, slicing, strip-cutting, dicing, shredding, and/or granulating food products. Certain types of size-reduction equipment are sometimes referred to as transverse slicers, a nonlimiting example of which is schematically represented in FIGS. 1 and 2. The transverse slicing machine 10 depicted in FIGS. 1 and 2 utilizes a rotating cutting wheel 12 having radially-extending cutting blades or knives 14 that define a cutting plane through which products 16 are advanced through a feed passage 18, for example, on a conveyor belt 28 toward the wheel 12 in a feed direction. As is shown for the cutting wheel 12, transverse slicers typically rotate about a horizontal axis 20, with the result that the cutting plane of the wheel 12 is vertical. In FIG. 2, the cutting wheel 12 can be seen as having a rim 22 surrounding a central hub 24 which together support the knives 14 so that each knife 14 spans the radial distance between the rim 22 and hub 24 of the cutting wheel 12. The hub 24 is mounted on a spindle 26 of the machine 10 that protrudes from a front face 30 of the machine 10 and coincides with the axis 20 of the wheel 12. Various types of transverse cutting wheels exist, including wheels disclosed in U.S. Pat. Nos. 5,992,284 and 6,792,841 that are representative of cutting wheels commercially known as the MICROSLICE®, manufactured by Urschel Laboratories, Inc. The MICROSLICE® cutting wheel is capable of making transverse slices in products advanced through the cutting plane in a rapid manner to enable high volume production of product slices 32 (FIG. 1), for example, food slices, of substantially uniform thickness. Modifications to the cutting knives of slicing machines of the type described above are capable of producing other size-reduced products. Nonlimiting examples include the addition of julienne knives as disclosed in U.S. Pat. Nos. 5,896,801 and 6,460,444, to produce a multidimensional cut that produces a diced product as opposed to a slice produced by a single dimensional cut.

Various other types of equipment have been proposed for producing products other than sliced and diced products. As examples, spiral-cut products are produced by equipment disclosed in U.S. Pat. No. 4,628,808, and ring-shaped products are produced by equipment disclosed in U.S. Pat. Nos. 5,010,796, 5,035,915, and 5,097,735. Potato products widely known as “curly fries” can be produced by equipment of types disclosed in U.S. Pat. Nos. 5,042,342, 5,174,181, 5,211,098, 5,385,074, and 5,473,967, which utilize rotating cutting heads. Products have been advanced to the cutting elements of such equipment by various means, for example, conveyor belts, delivery tubes, shafts, and water jets.

### BRIEF DESCRIPTION OF THE INVENTION

The present invention provides size-reduction machines equipped with cutting units suitable for performing size reduction operations on products, including but not limited to food products.

According to one aspect of the invention, a size-reduction machine includes a drive spindle, a feed passage, conveyor belts for delivering a product through the feed passage to an exit thereof, and a cutting unit installed at the exit of the feed passage. The cutting unit includes a mounting frame secured to the machine at the exit of the feed passage. The mounting frame defines a frame opening aligned with the exit of the feed passage so that a product exiting through the exit of the feed passage passes through the frame opening of the mounting frame. The cutting unit further includes a driven pulley rotatably mounted to the mounting frame and adapted to rotate about an axis that passes through the frame opening in the mounting frame, means connected to the spindle for rotating the driven pulley about the axis thereof, and a knife coupled to the driven pulley so as to rotate therewith about the axis of the driven pulley. The knife has a central axis that coincides with the axis of the driven pulley, an axial surface facing the feed passage, and at least one blade between the central axis thereof and an outer perimeter thereof. The blade defines a cutting edge and bounds an aperture between the central axis and the outer perimeter of the knife. The knife is aligned with the exit of the feed passage and the frame opening of the mounting frame so that a product exiting through the exit of the feed passage is engaged by the blade to produce a cut portion that passes through the aperture of the knife before passing through the frame opening of the mounting frame.

Other aspects of the invention include cutting units having the elements described above, and methods of installing cutting units on size-reduction machines. Such a method includes securing the mounting frame of the cutting unit to the machine at the exit of the feed passage so that the central axis of the knife, the axis of the driven pulley, and the frame opening of the mounting frame are axially aligned with the feed passage, and then rotationally connecting the driven pulley to the spindle.

Technical effects of the various aspects described above preferably include the capability for high volume production of a variety of size-reduced products and the ability to easily install and remove the cutting unit from a size-reduction machine as a unitary assembly.

Other aspects and advantages of this invention will be further appreciated from the following detailed description.

### BRIEF DESCRIPTION OF THE DRAWINGS

FIGS. 1 and 2 schematically represent side and front views of a transverse slicing machine equipped with a cutting wheel for producing transversely-sliced products.

FIGS. 3 and 4 are perspective views of a machine that shares certain common features with the machine shown in FIGS. 1 and 2, but on which a cutting unit has been installed to produce a wide variety of size-reduced products other than transversely-sliced products.

FIGS. 5 and 6 show, respectively, front and rear perspective views of a cutting unit of the type represented in FIGS. 3 and 4 in both assembled and disassembled states.

FIGS. 7 and 8 represent the production of spiral (“curly”) food products using the cutting unit of FIGS. 5 and 6 from products delivered to the cutting unit with, respectively, a two-belt or three-belt conveyor system.

FIGS. 9 and 10 show, respectively, front and rear perspective views of another cutting unit of the type represented in FIGS. 3 and 4 in both assembled and disassembled states.

FIGS. 11 and 12 represent the production of “spaghetti-cut” food products using the cutting unit of FIGS. 9 and 10 from products delivered to the cutting unit with, respectively, a two-belt or three-belt conveyor system.

FIGS. 13 and 14 show, respectively, front and rear perspective views of a third cutting unit of the type represented in FIGS. 3 and 4 in both assembled and disassembled states.

FIGS. 15 and 16 represent the production of spiral-cut food products using the cutting unit of FIGS. 13 and 14 from products delivered to the cutting unit with, respectively, a two-belt or three-belt conveyor system.

FIGS. 17 and 18 represent the production of ribbon-cut food products using a fourth cutting unit of the type represented in FIGS. 3 and 4 from products delivered to the cutting unit with, respectively, a two-belt or three-belt conveyor system.

FIGS. 19 through 32 represent various types of cutting knives that can be installed in the cutting units of FIGS. 3 through 18.

### DETAILED DESCRIPTION OF THE INVENTION

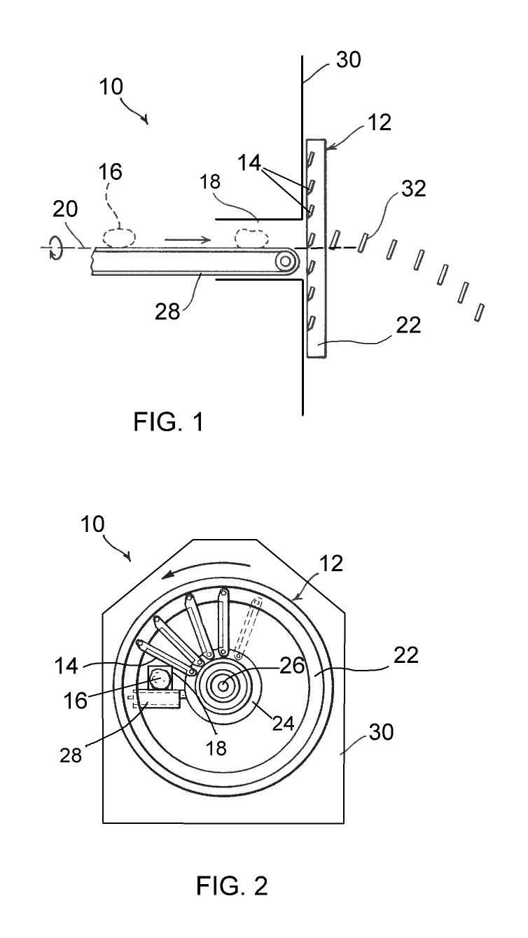

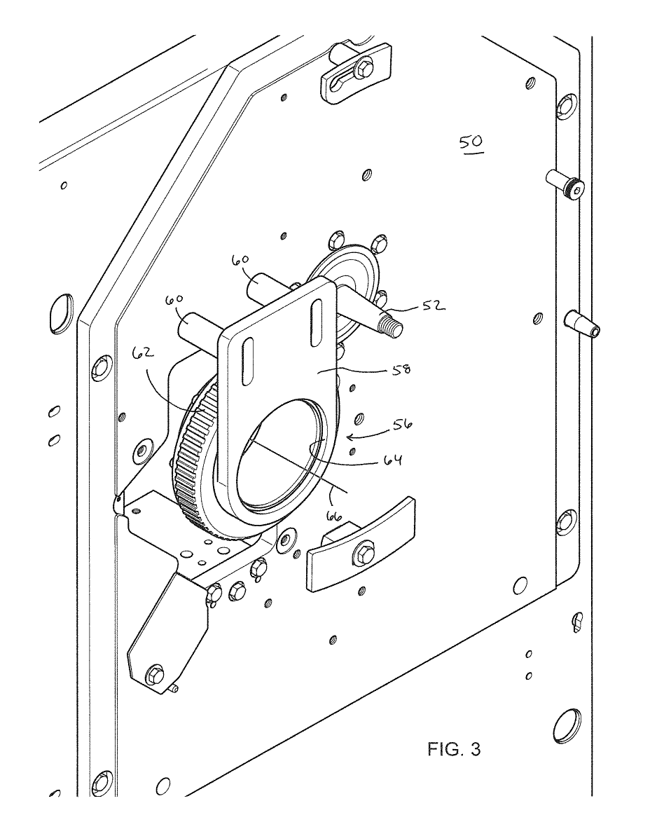

FIGS. 3 through 32 represent various cutting units and components thereof that can be installed on a size-reduction machine, a nonlimiting example of which is a machine having certain features similar to the transverse slicing machine 10 represented in FIGS. 1 and 2, and in some instances may be a modification or retrofit of the machine 10. In particular, nonlimiting embodiments of the invention will be illustrated and described hereinafter in reference to a size-reduction machine 50 having a drive spindle 52 and feed passage 54 (FIGS. 7, 8, 11, 12, and 15 through 18) arranged similarly to the spindle 26 and feed passage 18 of the machine 10 in FIGS. 1 and 2, though it will be appreciated that the teachings of the invention are more generally applicable to other types of size-reduction machines.

To facilitate the description provided below of the embodiments represented in the drawings, relative terms, including but not limited to, “vertical,” “horizontal,” “lateral,” “front,” “rear,” “side,” “forward,” “rearward,” “upper,” “lower,” “above,” “below,” “right,” “left,” etc., may be used in reference to the orientation of the machines 50 represented in the drawings, and therefore are relative terms that indicate the construction, installation and use of the invention and therefore help to define the scope of the invention.

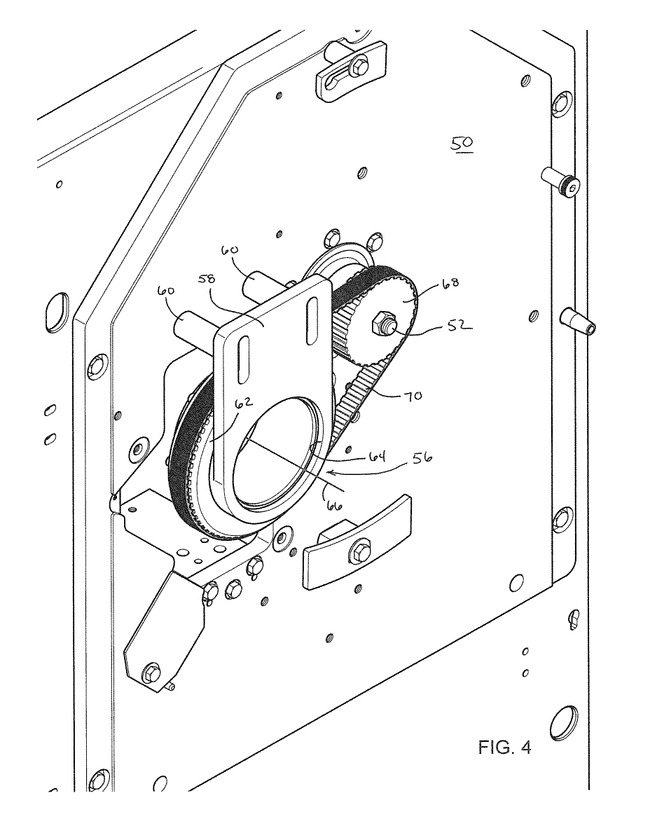

FIG. 3 is a fragmentary view depicting a front face of the machine 50 and a cutting unit 56 mounted thereto at the exit of the feed passage 54, which is concealed behind the cutting unit 56 in FIG. 3. The drive spindle 52 projects from the face of the machine 50 and can be driven to rotate by any suitable means (not shown), for example, an electric motor within the machine 50. The drive spindle 52 is laterally offset from the cutting unit 56. The cutting unit 56 includes a mounting frame 58 that is mounted to the machine 50 with spacers or posts 60, and a driven pulley 62 that is rotatably mounted to the frame 58. The frame 58 defines a frame opening 64 that is aligned with the feed passage 54 of the machine 50, so that products delivered through the feed passage 54 are able to exit the cutting unit 56 through the frame opening 64. The driven pulley 62 and frame opening 64 preferably share a common axis 66 about which the pulley 62 rotates. The axis 66 is shown in FIG. 3 as parallel to the axis of the spindle 52. FIG. 4 represents the same view as in FIG. 3, but with the inclusion of a drive pulley 68 mounted on the spindle 52, and a drive belt 70 that rotationally connects the driven pulley 62 to the drive pulley 68.

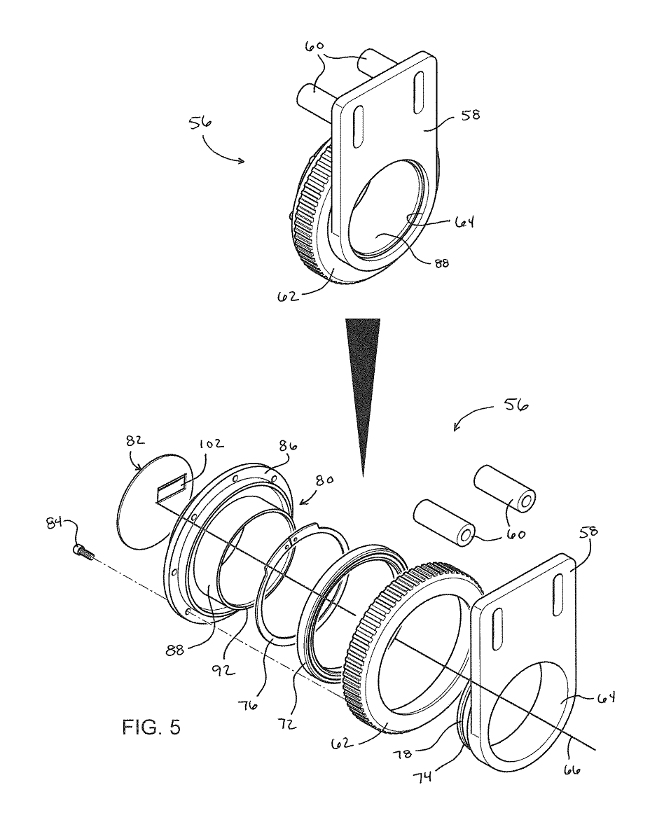

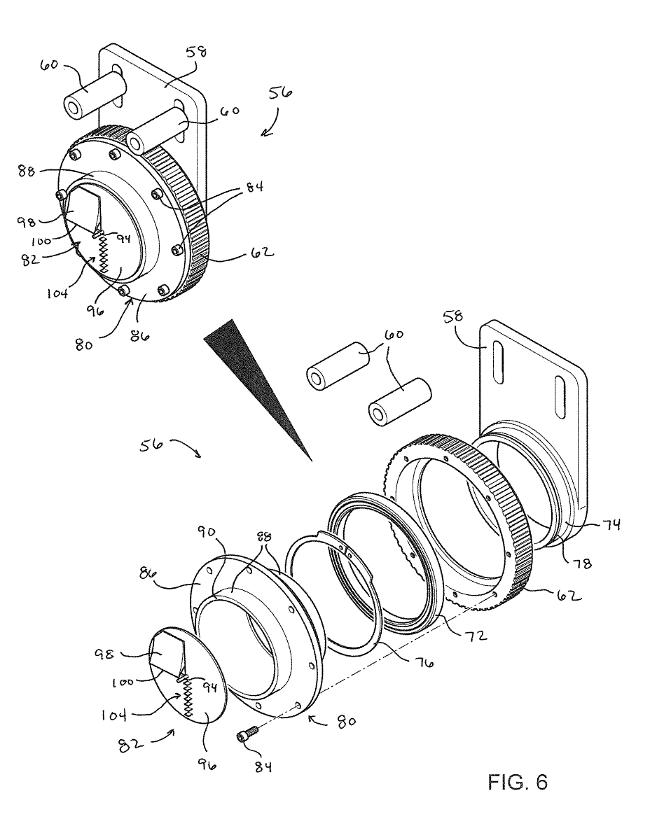

FIGS. 5 and 6 depict reverse views of the cutting unit 56 and show the unit 56 assembled (upper images) and in an exploded view (lower images). As evident from comparing FIGS. 3 through 6, the cutting unit 56 has the ability to be installed and removed from the machine 50 as a complete unit. In particular, fasteners (not shown) can be used in conjunction with the posts 60 to mount the frame 56 to the machine 50 so that the cutting unit 56 is spaced apart and cantilevered from the face of the machine 50. The exploded views of FIGS. 5 and 6 depict a particular but nonlimiting embodiment of the cutting unit 56 as further comprising a bearing 72 that rotatably supports the pulley 62 on a mounting sleeve 74 that surrounds the opening 64 of the frame 58, a snap ring 76 that retains the pulley 62 and bearing 72 on the sleeve 74 by engaging a snap ring groove 78 formed in the sleeve 74, a collar 80, and a knife 82, all of which are shown as being concentric and aligned on an axis that coincides with the axis 66 of the frame opening 64 so that a product exiting through the exit of the feed passage 54 is able to pass through the cutting unit 56 and exit through its opening 64. The collar 80 is secured to the cutting unit 56 as a result of being coupled to the pulley 62, for example, with fasteners 84 (one of which is shown) that clamp a mounting flange 86 of the collar 80 to the pulley 62, such that the collar 80 rotates with the pulley 62. The collar 80 includes a sleeve 88 that defines openings 90 and 92 at its oppositely-disposed axial ends. When assembled, the sleeve 88 of the collar 80 passes through the bearing 72 and pulley 62 and is received in the mounting sleeve 74 so that the opening 92 is located at or near the opening 64 of the frame 56, and the opposite opening 90 faces the feed passage 54. The knife 82 is mounted at or within the opening 90 and can be secured thereto in any suitable manner, for example, with a metallurgical joint.

The knife 82 can be seen in FIG. 6 as having a planar circular shape and a center pin 94 that protrudes from a planar axial surface 96 of the knife 82. The pin 94 lies on a central axis of the knife 82, which is represented in FIG. 6 as coinciding with the axis 66 common to the pulley 62, frame opening 64, and collar 80. The knife 82 further includes a blade 98 located between the pin 94 (central axis) and the outer perimeter of the surface 96. The blade 98 protrudes from the surface 96 to define a cutting edge 100, and bounds an aperture 102 (FIG. 5) that is also located between the central axis (pin 94) and outer perimeter of the surface 96. The required rigidity of the blade 98 and sharpness of the cutting edge 100 will likely vary depending on the hardness and size of the produce being processed. The collar 80 aligns the knife 82 with the exit of the feed passage 54 and frame opening 64 so that a product exiting through the exit of the feed passage 54 will be engaged by the blade 98 to produce a reduced-size product that passes through the aperture 102 before continuing through and eventually exiting the unit 56 through the opening 64 of the mounting frame 58. The distance between the cutting edge 100 and the axial surface 96 of the knife 82 perpendicular to the surface 96 defines a gate opening that determines the thickness of the portion cut from a product engaged by the knife blade 98. The axial surface 96 of the knife 82 faces the feed passage 54 when the cutting unit 56 is installed on the machine 50, and as such the pin 94 is able to engage and stabilize a product being sliced by the blade 98.

In the embodiment shown in FIGS. 5 and 6, the blade 98 and its cutting edge 100 are parallel to the axial surface 96 and extend along a radial of the knife 82 between the central axis (pin 94) of the knife 82 and a location at the outer perimeter of the knife 82. Furthermore, the cutting edge 100 is represented as being straight so that portions cut from a product by the blade 98 are of substantially uniform thickness. Finally, the knife 82 is represented as including a plurality of julienne blades 104, each extending perpendicularly from the axial surface 96 of the knife 82. The julienne blades 104 are aligned and spaced apart along a radial of the knife 82 that is approximately ninety degrees from the radial on which the cutting edge 100 lies. The julienne blades 104 precut (slit) a product before it encounters the blade 98 such that portions cut from a product by the blade 98 are spiral-cut strips. As a nonlimiting example, FIG. 7 depicts potatoes as the products 108 being fed to the cutting unit 56 and the resulting reduced-size products 106 as “curly fries.”

FIG. 7 additionally depicts the feed passage 54 as comprising a conveyor belt system, in which two conveyor belts 110 are arranged to define a V-shaped cradle in which the products 108 are supported while being delivered through the feed passage 54. FIG. 8 represents another embodiment in which a third conveyor belt 110 has been added and arranged relative to the V-shaped cradle defined by the other two belts 110 so that the three belts 110 contact three different sides of the products 108 as they are delivered through the feed passage 54. The third belt 110 is mounted with a spring-biased unit 112 so that the third belt 110 can move relative to the other two belts 110 to positively engage products 108 of different sizes.

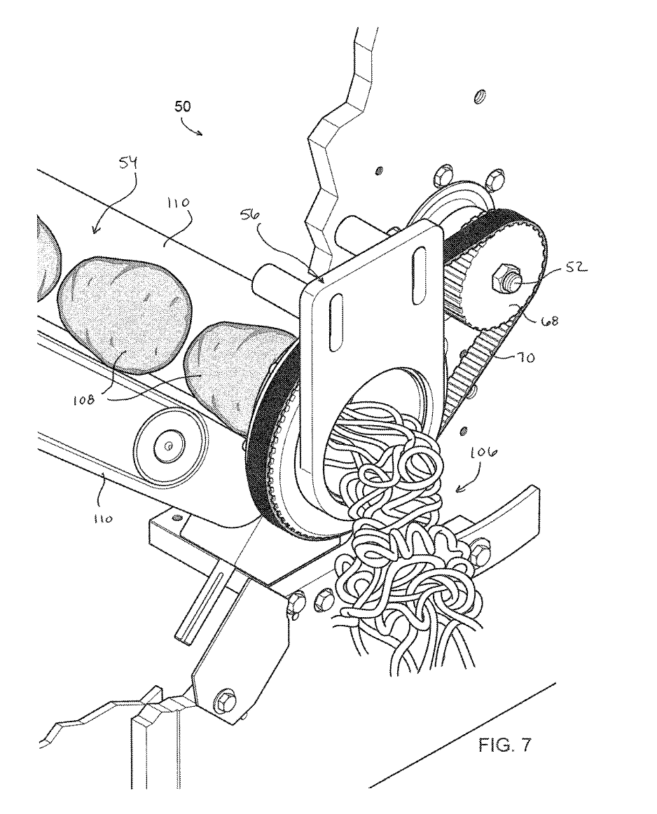

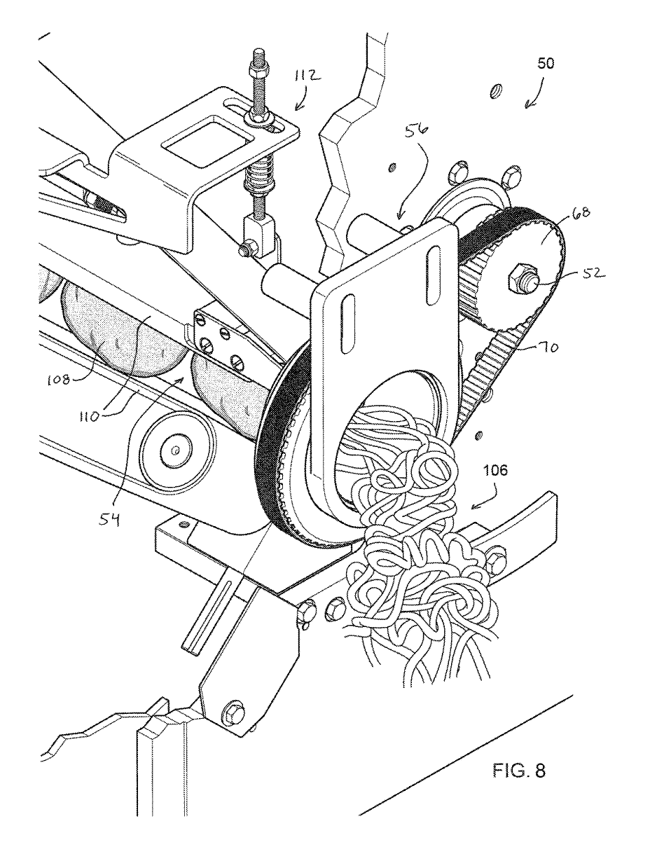

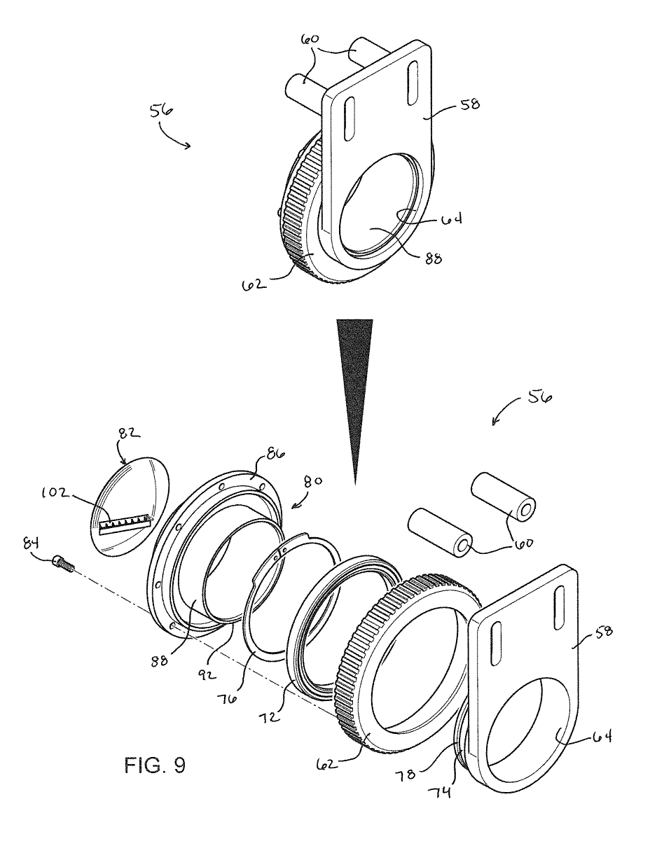

FIGS. 9 through 18 depict additional embodiments of cutting units that differ from the cutting unit 56 of FIGS. 5 through 8 as a result of being equipped with knives having different configurations. In view of similarities among the embodiments, consistent reference numbers are used in FIGS. 9 through 18 to identify the same or functionally related elements as those described for FIGS. 5 through 8, and the following discussion of FIGS. 9 through 18 will focus primarily on aspects of the further embodiments that differ from the first embodiment in some notable or significant manner. Other aspects of the further embodiments not discussed in any detail can be, in terms of structure, function, materials, etc., essentially as was described for the first embodiment.

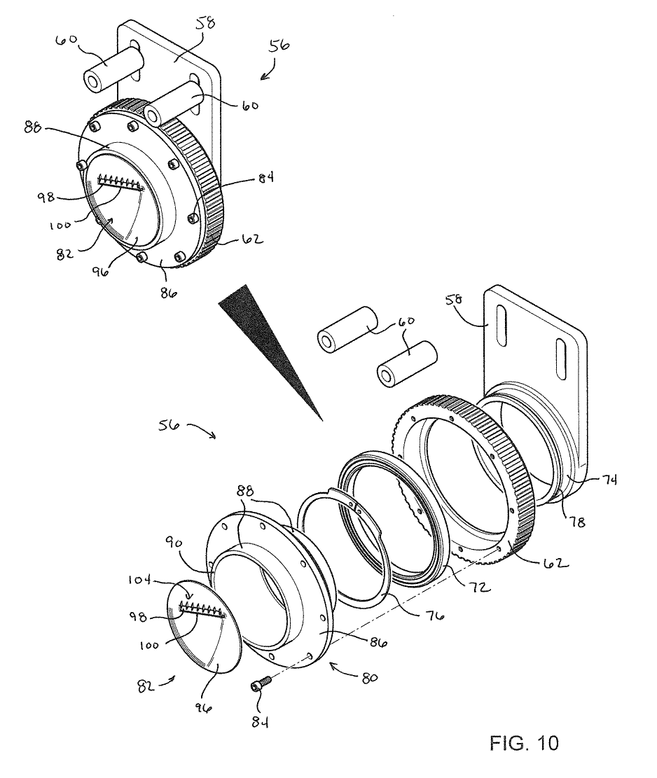

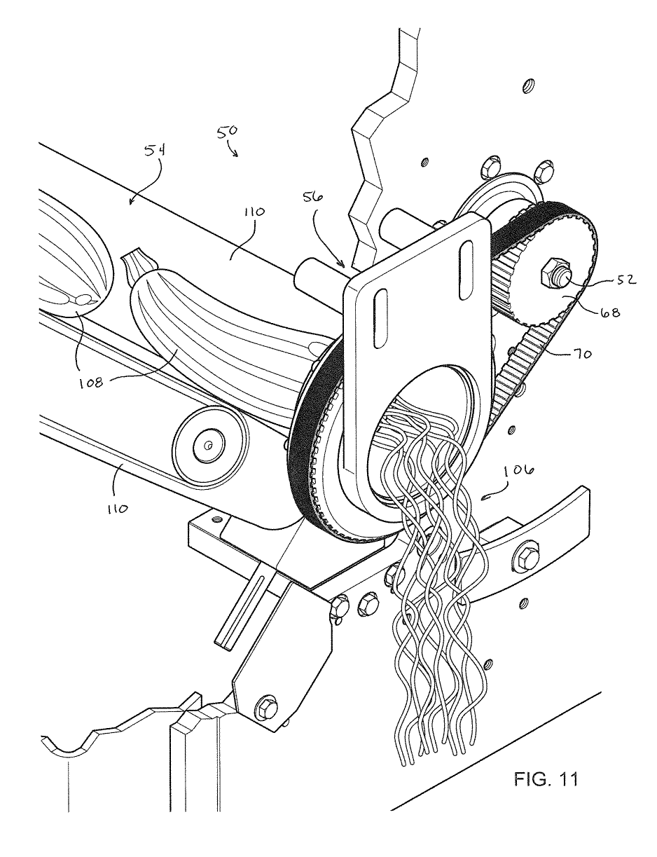

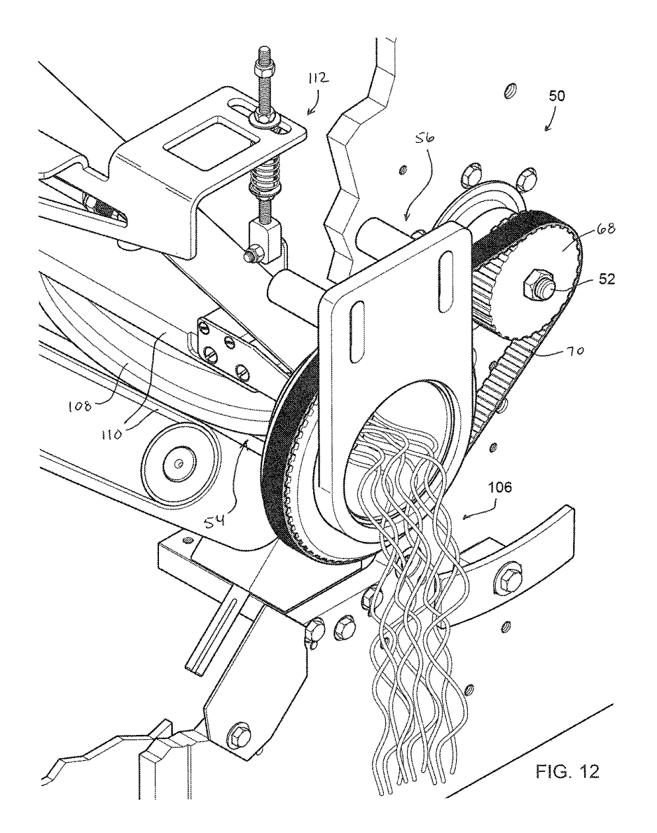

In regard to the embodiment of the cutting unit 56 of FIGS. 9 through 12, FIGS. 9 and 10 depict the knife 82 as having a conical shape with a pin 94, a blade 98 protruding from the conical-shaped axial surface 96 of the knife 82, and julienne blades 104 located on the blade 98 and aligned in a row immediately after, adjacent, and parallel to the cutting edge 100 of the blade 98. The julienne blades 104 protrude from the surface of the blade 98 opposite the axial surface 96. Consequently, the placement of the julienne blades 104 in FIGS. 9 and 10 is after the cutting edge 100, as opposed to ahead of the cutting edge 100 as depicted in FIGS. 5 and 6. As such, the julienne blades 104 of FIGS. 9 and 10 form strips by slitting a slice immediately after it is formed by the blade 98, whereas the julienne blades 104 of FIGS. 5 and 6 form slits in the body of the product after which the blade 98 slices the slit face of the body to form strips. FIGS. 11 and 12, which correspond to FIGS. 7 and 8 of the first embodiment, depict the cutting unit 56 of FIGS. 9 and 10 as yielding a “spaghetti-cut” product 106 produced from products 108 represented as zucchini.

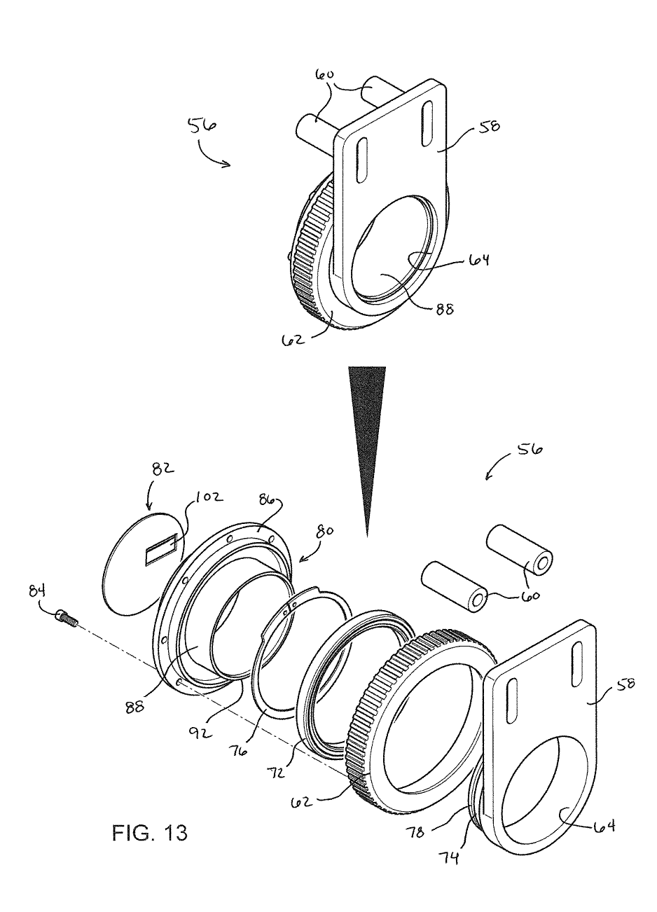

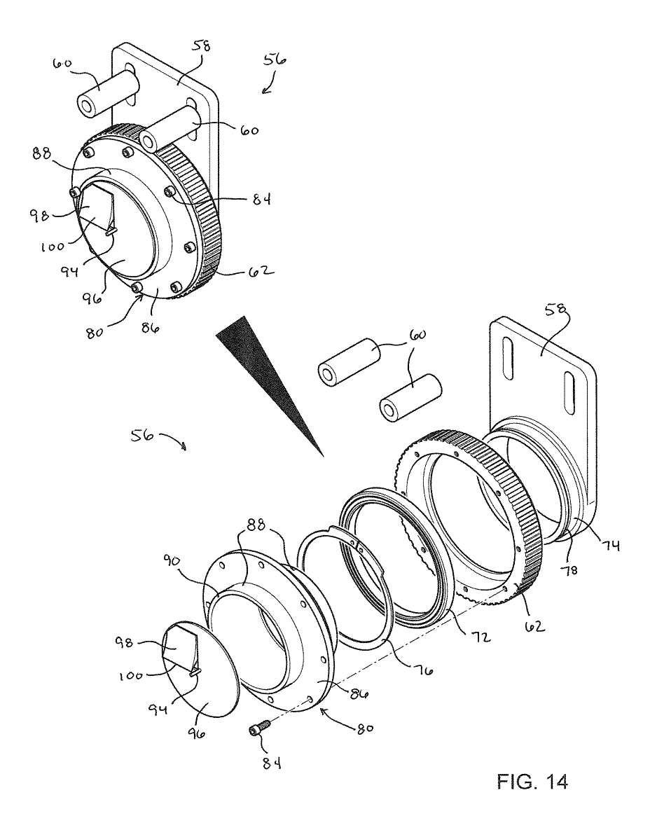

FIGS. 13 through 16 represent another embodiment of the cutting unit 56. FIGS. 13 and 14 depict a knife 82 that lacks julienne blades, but has a single blade 98 similar to the knife 82 of FIGS. 5 and 6. In the absence of julienne blades, the blade 98 of the knife 82 produces a reduced-size product 106 as a slice. FIGS. 15 and 16, which correspond to FIGS. 7 and 8 of the first embodiment, depict the cutting unit 56 of FIGS. 13 and 14 as yielding a “spiral-cut” product 106 produced from products 108 represented as potatoes. FIGS. 17 and 18 illustrate a “ribbon-cut” product 106 produced from potatoes 108 as a result of using a knife (not shown) that has a conical shape (e.g., similar to the knife 82 of FIGS. 9 and 10) and a narrower gate opening, but is otherwise similar to the knife 82 of FIGS. 13 and 14.

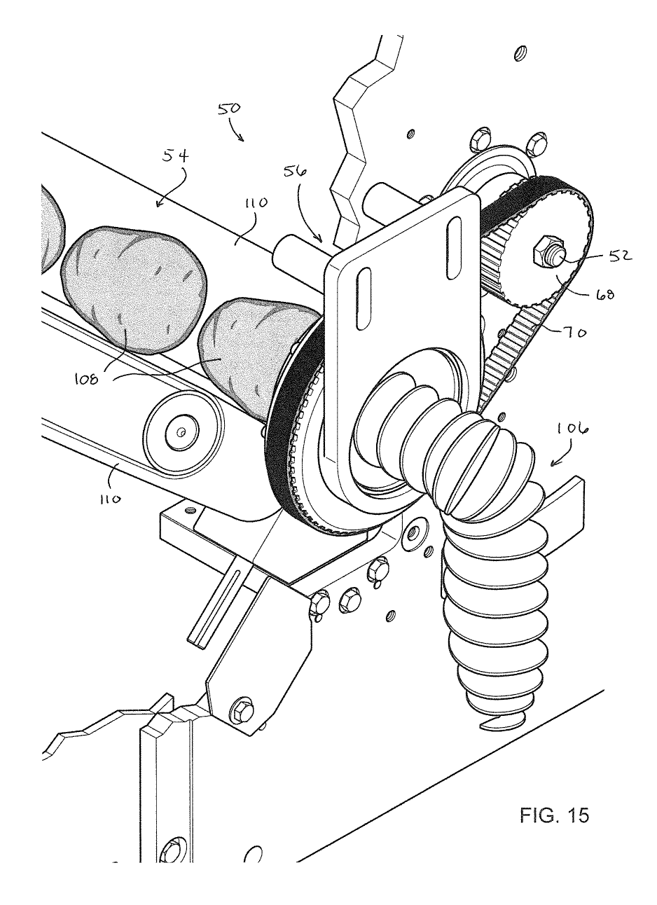

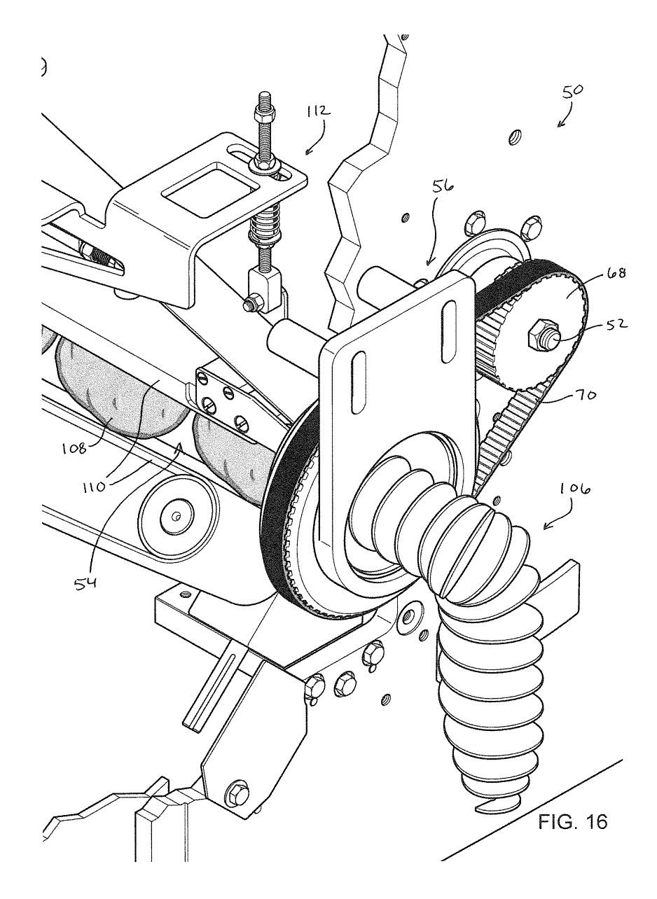

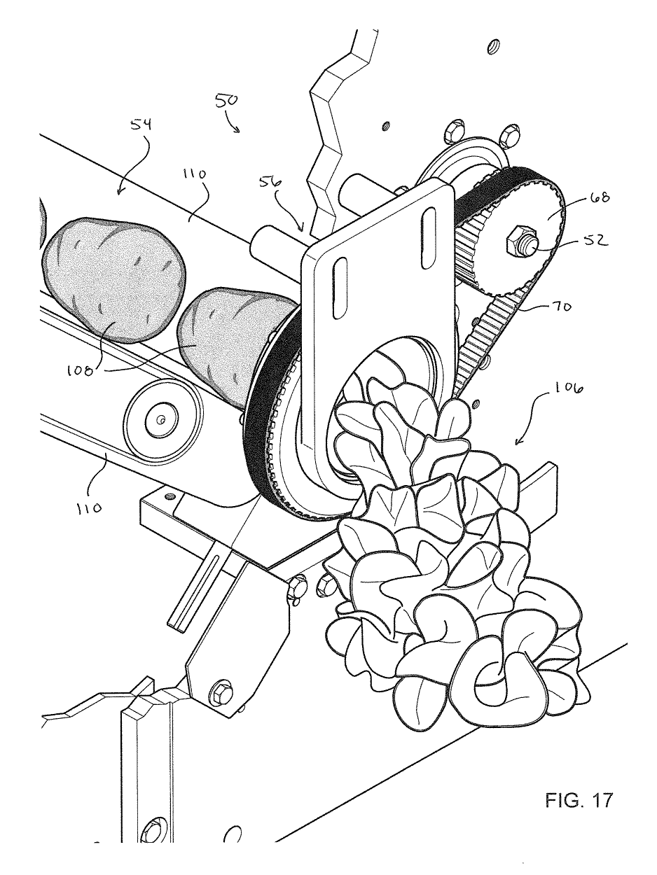

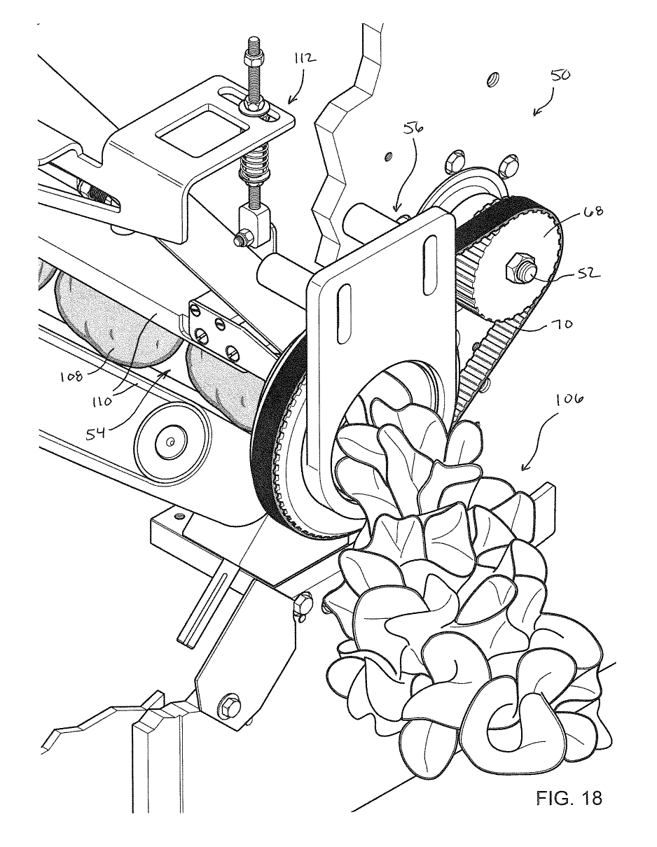

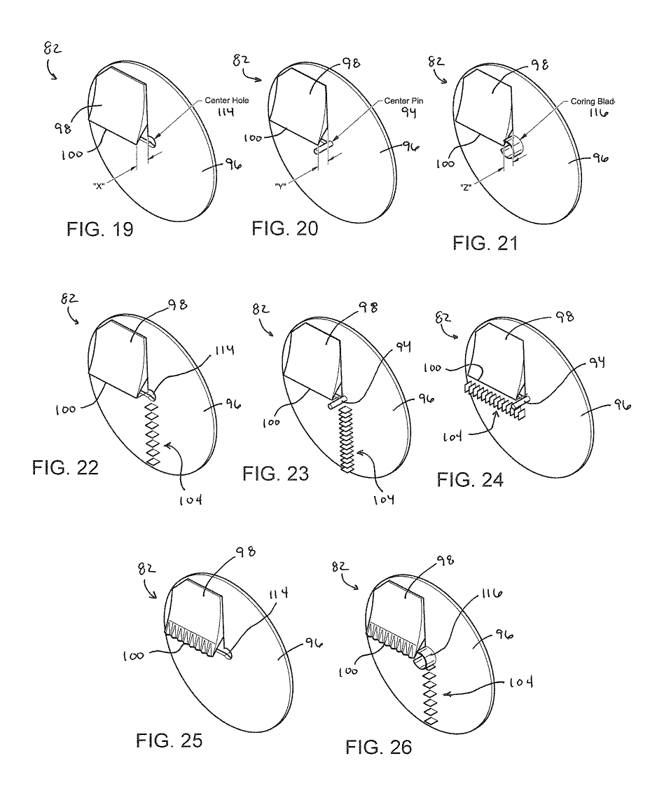

FIGS. 19 through 32 represent various different configurations of cutting knives 82 that can be installed in the cutting units 56 of FIGS. 3 through 18. For convenience, consistent reference numbers are used throughout FIGS. 19 through 32 to identify the same or functionally related elements.

The knife 82 shown in FIG. 19 is similar to the knife 82 of FIGS. 13 and 14, but has a center hole 114 instead of the center pin 94. The hole 114 can be advantageous as a relief in the case of products that easily tear. The knife 82 shown in FIG. 21 is similar to the knives 82 of FIGS. 13, 14 and 19, but has a C-shaped coring blade 116 instead of the center pin 94 and center hole 114. The coring blade 116 surrounds the central axis of the knife 82 and extends perpendicularly from the axial surface 96 of the knife 82 so as to face the feed passage 54 when the knife 82 is installed in the machine 50, resulting in a core being cut from a product as it is sliced by the blade 98 of the knife 82. The knife 82 shown in FIG. 22 is similar to the knife 82 of FIGS. 5 and 6, but has a center hole 114 instead of center pin 94. The knife 82 shown in FIG. 23 is similar to the knife 82 of FIGS. 5 and 6, but with more julienne blades 104 that are more closely spaced than those of FIGS. 5 and 6. The knife 82 shown in FIG. 24 is similar to the knife 82 of FIG. 23, but with the julienne blades 104 arranged in a row that is parallel to and immediately adjacent the blade 98 and its cutting edge 100.

The knife 82 shown in FIG. 25 is similar to the knife 82 of FIG. 19, except the cutting edge 100 is corrugated instead of straight. As a result, a reduced-size product produced by the knife 82 of FIG. 25 will be a spiral-cut product corresponding to that shown in FIGS. 15 and 16, but will have a sinusoidal (“crinkle”) cross-sectional shape. The knife 82 shown in FIG. 26 combines the corrugated cutting edge 100 of FIG. 25, the julienne blades 104 of FIG. 22, and the coring blade 116 of FIG. 21.

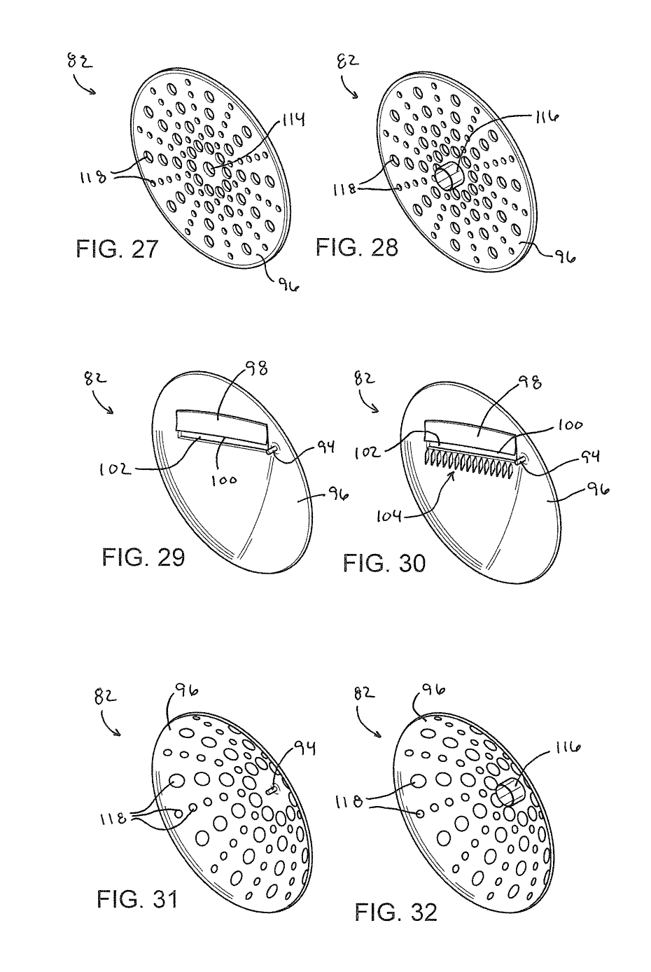

The knives 82 of FIGS. 27 and 28 differ from the previous knives 82 by forming a plurality of blades 98 with apertures 118 that are distributed between the central axis and outer perimeter of the knife 82. The knives 82 of FIGS. 27 and 28 differ from each other by having either a central hole 114 (similar to FIG. 19) or a coring blade 116 (similar to FIG. 21). Each blade 98 defines a grating edge (corresponding to a cutting edge 100 of a previous knife 82), such that each aperture 118 that forms a blade 98 is bound by a grating edge. For grating applications, the number, sizes and shapes of the apertures 118 and the depth of the axial surface 96 of the knife 82 will influence shred or grating size. Whereas some of the apertures 118 are specifically formed for cutting product, the role of other apertures 118 may be for relief or the passage of the resulting reduced-size product (corresponding to an aperture 102 of a previous knife 82). The apertures 118 that form blades 98 for cutting product may be formed by punch perforation to yield sharp grating edges that act in a manner similar to sandpaper to abrade product.

FIG. 29 depicts a knife 82 configured for producing ribbon-cut products that are the same or similar to the ribbon-cut product discussed in reference to FIGS. 17 and 18. The knife 82 shown in FIG. 30 is similar to the knife 82 of FIGS. 9 and 10, but shows the julienne knives 104 located upstream of the blade 98 and immediately adjacent and parallel to its cutting edge 100 and aperture 102.

Finally, FIGS. 31 and 32 depict knives 82 similar to those shown in FIGS. 27 and 28, but modified to be conical-shaped. The knife 82 of FIG. 31 includes a central pin 94, whereas the knife 82 of FIG. 32 has a coring blade 116 similar to FIG. 28.

While the invention has been described in terms of specific or particular embodiments, it is apparent that other forms could be adopted by one skilled in the art. For example, the size-reduction machine 50, cutting unit 56, and components thereof could differ in appearance and construction from the embodiments described herein and shown in the drawings, functions of certain components of the machine 50 and cutting unit 56 could be performed by components of different construction but capable of a similar (though not necessarily equivalent) function, and various materials could be used in the manufacturing of the machine 50, cutting unit 56, and their components. Furthermore, the various features of the knives 82 (blades 98, julienne blades 104, pins 94, central hole 114, coring blade 116, apertures 118, etc.) could be combined on a single knife 82 in various combinations. Accordingly, it should be understood that the invention is not limited to any embodiment described herein or illustrated in the drawings. It should also be understood that the phraseology and terminology employed above are for the purpose of describing the illustrated embodiments, and do not necessarily serve as limitations to the scope of the invention. Therefore, the scope of the invention is to be limited only by the following claims.

1. A size-reduction machine comprising a drive spindle, a feed passage, at least first and second conveyor belts for delivering a product through the feed passage to an exit thereof, and a cutting unit installed at the exit of the feed passage, the cutting unit comprising:
a mounting frame secured to the machine at the exit of the feed passage, the mounting frame defining a frame opening aligned with the exit of the feed passage so that a product exiting through the exit of the feed passage passes through the frame opening of the mounting frame;
a driven pulley rotatably mounted to the mounting frame and adapted to rotate about an axis that passes through the frame opening in the mounting frame;
means connected to the spindle for rotating the driven pulley about the axis thereof; and
a knife coupled to the driven pulley so as to rotate therewith about the axis of the driven pulley, the knife having a central axis that coincides with the axis of the driven pulley, an axial surface facing the feed passage, and at least a first blade between the central axis thereof and an outer perimeter thereof, the first blade defining a first cutting edge and bounding a first aperture between the central axis and the outer perimeter of the knife, the knife being aligned with the exit of the feed passage and the frame opening of the mounting frame so that a product exiting through the exit of the feed passage is engaged by the first blade to produce a reduced-size product that passes through the first aperture before passing through the frame opening of the mounting frame.

2. The size-reduction machine according to claim 1, further comprising a collar for coupling the knife to the driven pulley, the collar having a through-passage that defines first and second openings at respectively oppositely-disposed first and second axial ends thereof, wherein the first opening of the collar faces the feed passage and the knife resides in the first opening.

3. The size-reduction machine according to claim 2, wherein the collar has an annular flange that surrounds the through-passage and is secured to the driven pulley.

4. The size-reduction machine according to claim 1, wherein the mounting frame has a mounting sleeve surrounding the frame opening, and the driven pulley and the knife are rotationally mounted on and supported by the mounting sleeve.

5. The size-reduction machine according to claim 1, wherein the mounting frame is secured to the machine so that the cutting unit is cantilevered from a surface thereof.

6. The size-reduction machine according to claim 1, wherein the first and second conveyor belts define a V-shaped cradle in which a product is supported while being delivered through the feed passage.

7. The size-reduction machine according to claim 6, further comprising a third conveyor belt arranged relative to the V-shaped cradle so that the first, second and third conveyor belts contact three different sides of a product as the product is being delivered through the feed passage.

8. The size-reduction machine according to claim 1, wherein the first blade protrudes from the axial surface of the knife toward the feed passage and the first cutting edge thereof is parallel to the axial surface and extends along a first radial of the knife between the central axis of the knife and a location at the outer perimeter of the knife.

9. The size-reduction machine according to claim 8, wherein the first cutting edge is a straight cutting edge.

10. The size-reduction machine according to claim 8, wherein the first cutting edge is a corrugated cutting edge.

11. The size-reduction machine according to claim 8, wherein the first blade is configured to produce a slice from the product, the knife further comprising a plurality of second blades, each of the second blades extending perpendicularly to the axial surface of the knife and being positioned relative to the first blade to slit the slice immediately after the slice is formed by the knife 82 so that the reduced-size product comprises strips.

12. The size-reduction machine according to claim 8, wherein the first blade is configured to produce a slice from the product, the knife further comprising a plurality of second blades, each of the second blades extending perpendicularly to the axial surface of the knife and being positioned relative to the first blade to slit the product before the product is sliced by the knife so that the reduced-size product comprises strips.

13. The size-reduction machine according to claim 8, further comprising a C-shaped coring blade that surrounds the central axis of the knife and extends perpendicularly from the axial surface of the knife toward the feed passage.

14. The size-reduction machine according to claim 8, wherein the axial surface of the knife is planar.

15. The size-reduction machine according to claim 8, wherein the axial surface of the knife is conical-shaped.

16. The size-reduction machine according to claim 1, wherein the first blade is one of a plurality of grating blades of the knife that are distributed between the central axis and the outer perimeter of the knife, the first cutting edge is one of a plurality of grating edges defined by the grating blades, and the first aperture is one of a plurality of grating apertures bound by the plurality of grating edges.

17. The size-reduction machine according to claim 16, wherein the axial surface of the knife is planar.

18. The size-reduction machine according to claim 16, wherein the axial surface of the knife is conical-shaped.

19. The cutting unit according to claim 1.

20. A method of installing the cutting unit of claim 1 on the size-reduction machine of claim 1, the method comprising:
securing the mounting frame to the machine at the exit of the feed passage so that the central axis of the knife, the axis of the driven pulley, and the frame opening of the mounting frame are axially aligned with the feed passage; and
rotationally connecting the driven pulley to the spindle.
